(19) United States
(12) Patent Application Publication
(10) Pub. No.: US 2025/0153069 A1
(43) Pub. Date: May 15, 2025

(54) CUSTOMIZABLE BUBBLE CANNON

(71) Applicant: LIGHTUPTOYS.COM, LLC, Sellersburg, IN (US)

(72) Inventors: Joshua C. Kelly, New Albany, IN (US); Christopher D. Kelly, New Albany, IN (US); Max Armendariz Lalama, Sellersburg, IN (US); Christopher W. Chung, Orlando, FL (US); Sindahl Evans, Georgetown, IN (US)

(21) Appl. No.: 18/939,656

(22) Filed: Nov. 7, 2024

Related U.S. Application Data
(60) Provisional application No. 63/597,739, filed on Nov. 10, 2023.
(60) Provisional application No. 63/560,009, filed on Mar. 1, 2024.

(51) Int. Cl. A63H 33/28; A63H 29/22; F21V 33/00

(52) U.S. Cl. CPC A63H 33/28; F21V 33/008; A63H 29/22

(57) ABSTRACT

A customizable bubble cannon which includes a housing with a first and second end and a mounting plate secured to an outer surface. Secured within the first end of the housing is a fan that directs air through the second end of the housing and secured to the second end is a cover assembly which includes an LED ring. Secured internally within the housing is at least one bubble cartridge with a nozzle that is directed to project bubbles through the cover assembly. An electronics control box is secured to a side of the housing and contains a printed circuit board, which is electrically connected to the LED ring, the at least on bubble cartridge, and the fan for manual and/or wireless activation. A solution reservoir is secured to the body of the cannon from which solution is pumped to the nozzle through a solution channel.

### CROSS-REFERENCE TO RELATED APPLICATIONS

This application claims benefit of provisional application No. 63/597,739 filed on Nov. 10, 2023 (which is pending) and also claims the benefit of provisional application No. 63/560,009 filed on Mar. 1, 2024 (which is pending). All publications, patents and patent applications referred to herein are incorporated by reference in their entirety.

### FIELD OF INVENTION

The present disclosure relates generally to a bubble cannon. More particularly, a customizable bubble cannon that is affixable to any surface and includes an LED light ring.

### BACKGROUND OF THE INVENTION

Toy bubble guns and cannons exist, but they are significantly limited in usage as they are not easily customizable to user specifications. This is mainly due to the need for a large fan and/or multiple fans and a significant number of internal components to create enough bubbles and to project them at a meaningful distance. Therefore, known bubble cannons are heavy, large and immobile. This limits the cannon significantly as bubbles are only capable of projecting in one direction once installed. Moreover, since these known cannons are so heavy, once they are installed, they cannot be repositioned or moved.

### SUMMARY OF THE INVENTION

A bubble cannon, which includes a cylindrical housing with a first and second end. A fan is secured within the first end of the housing and a cover assembly is secured to the second end of the housing. The cover assembly includes a base secured to a lens with an LED ring secured therebetween. An inner circumference of the cover assembly includes a mesh grill with at least one opening. Secured within the housing is at least one bubble cartridge, which includes an enclosure containing a pump, a motor and an air producing device that is positioned adjacent to an air duct. A nozzle is secured to the air duct within the at least one opening of the cover assembly. An electronics control box is secured to a side of the housing and contains a printed circuit board which controls activation of various components of the bubble cannon. A bubble solution reservoir is secured to a side of the housing and contains a first end of a bubble solution channel. The second end of the bubble solution channel connects to the nozzle.

### BRIEF DESCRIPTION OF THE FIGURES

FIG. 1 shows a top, side perspective view of a bubble cannon.

FIG. 2 shows a front view of the bubble cannon shown in FIG. 1.

FIG. 3 shows a back view of the bubble cannon shown in FIG. 1.

FIG. 4 shows a right-side view of the bubble cannon shown in FIG. 1.

FIG. 5 shows a left-side view of the bubble cannon shown in FIG. 1.

FIG. 6 shows a top view of the bubble cannon shown in FIG. 1.

FIG. 7 shows a bottom view of the bubble cannon shown in FIG. 1.

FIG. 8 shows a front cross section view of the bubble cannon shown in FIG. 1.

FIG. 9 shows a right side cross section view of the bubble cannon shown in FIG. 1.

FIG. 10 shows an exploded view of the bubble cannon shown in FIG. 1.

FIG. 11 shows various electrical wiring connections of the bubble cannon shown in FIG. 1.

FIG. 12 shows the bubble cannon shown in FIG. 1 secured within an enclosure and secured to a mobile cart.

FIG. 13 shows the bubble cannon shown in FIG. 12 affixed to the mobile cart.

### DETAILED DESCRIPTION

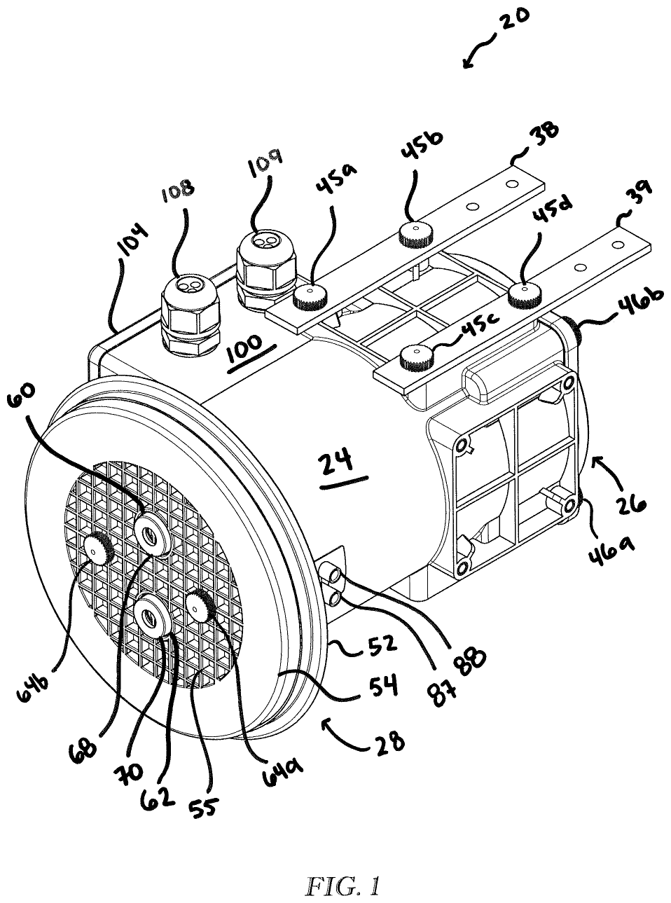

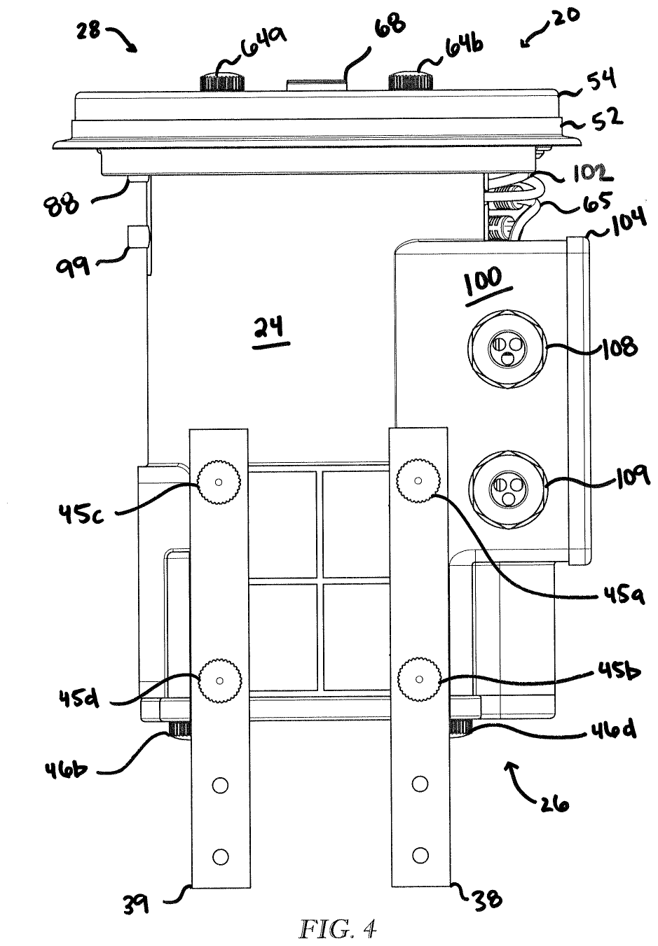

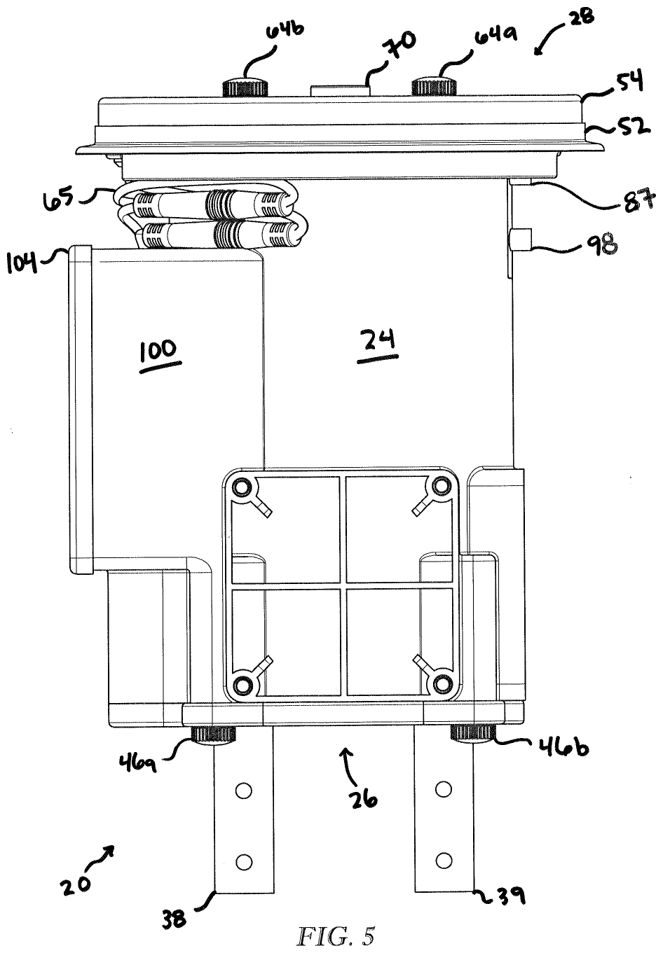

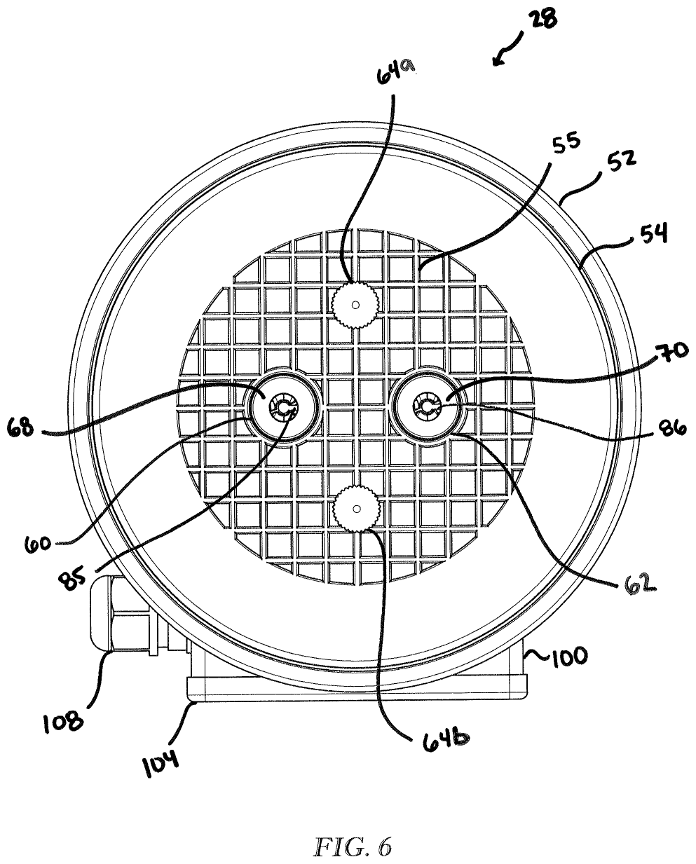

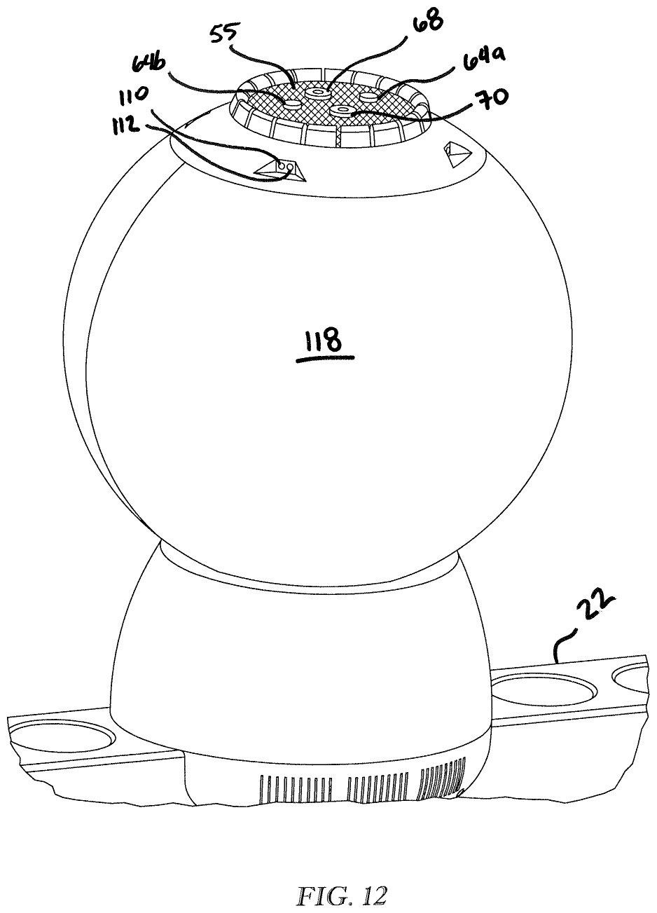

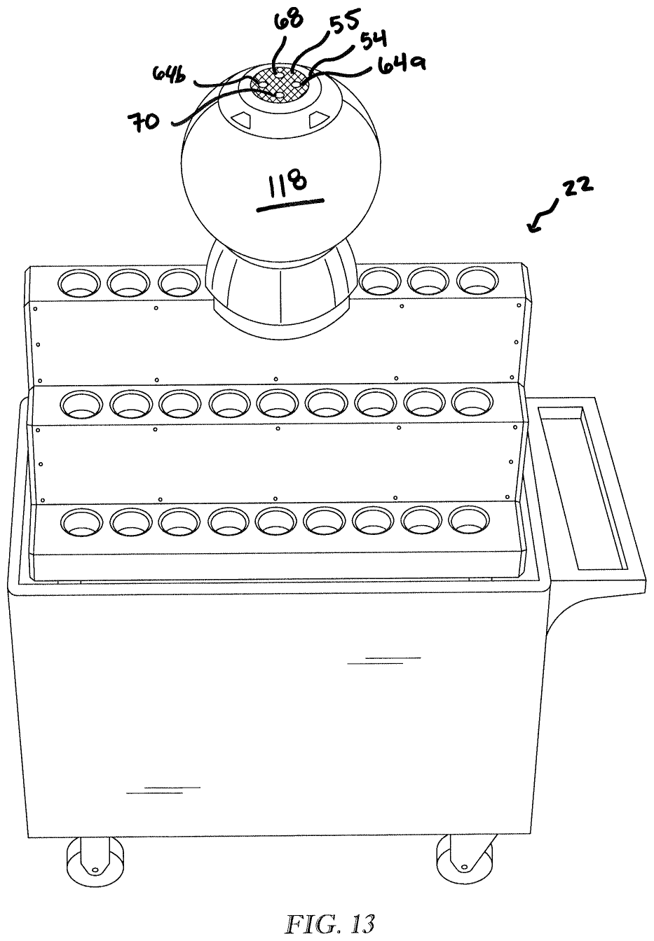

FIGS. 1-11 shows various views of a bubble cannon 20 and FIGS. 12-13 show one way in which this bubble cannon is securable to a mobile cart 22. As shown in FIGS. 1-5 and 8-11, the bubble cannon includes a cylindrical housing 24 with a first end 26 and a second end 28. Secured within the first end is a fan 30 and secured to the second end is a cover assembly 36. The housing is hollow and secured internally therein and positioned towards the second end of the housing is a first and second bubble cartridge (32, 34). Secured to an outer surface of the housing is an electronics control box 100, which contains a printed circuit board (“PCB”) 50, which is programmed to activate, whether manually, wirelessly, and/or remotely, the first and second bubble cartridges, the fan and a LED ring 56, which is secured within the cover assembly. Further secured to the outer surface of the housing via screws 45a-d is a first and second mounting plate (38, 39). These mounting plates advantageously affix the bubble cannon to any surface and at any angle. Due to the efficiency of the bubble cannon in producing bubbles and projecting them at a far distance, the bubble cannon is lighter in weight and is easily affixable to any surface via the use of only two mounting plates. Therefore, bubbles can be shot in any direction and the cannon is capable of readjustment and repositioning after originally being secured to a surface. This resolves limitations of known bubble cannons that were only capable of shooting bubbles in one direction and were stationary once installed.

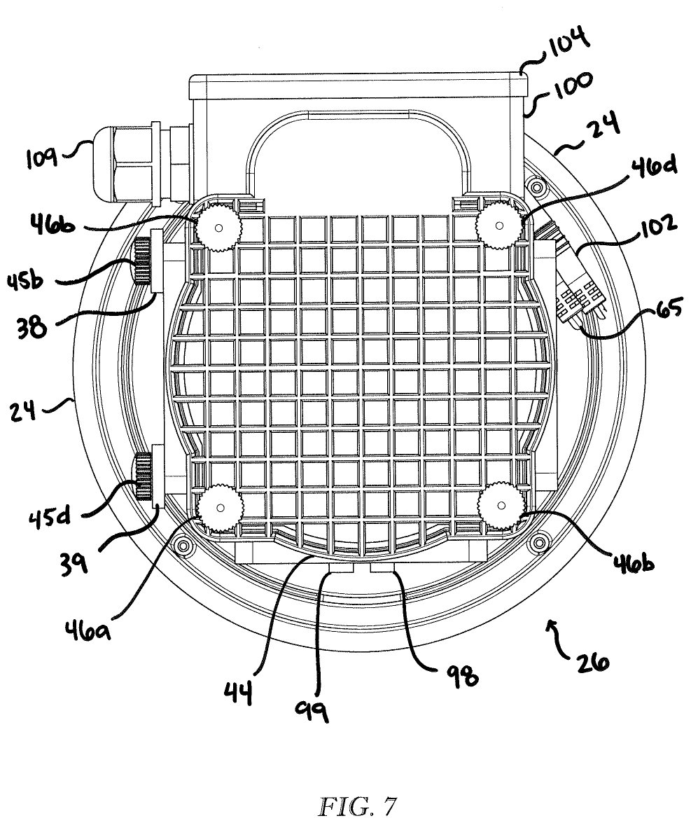

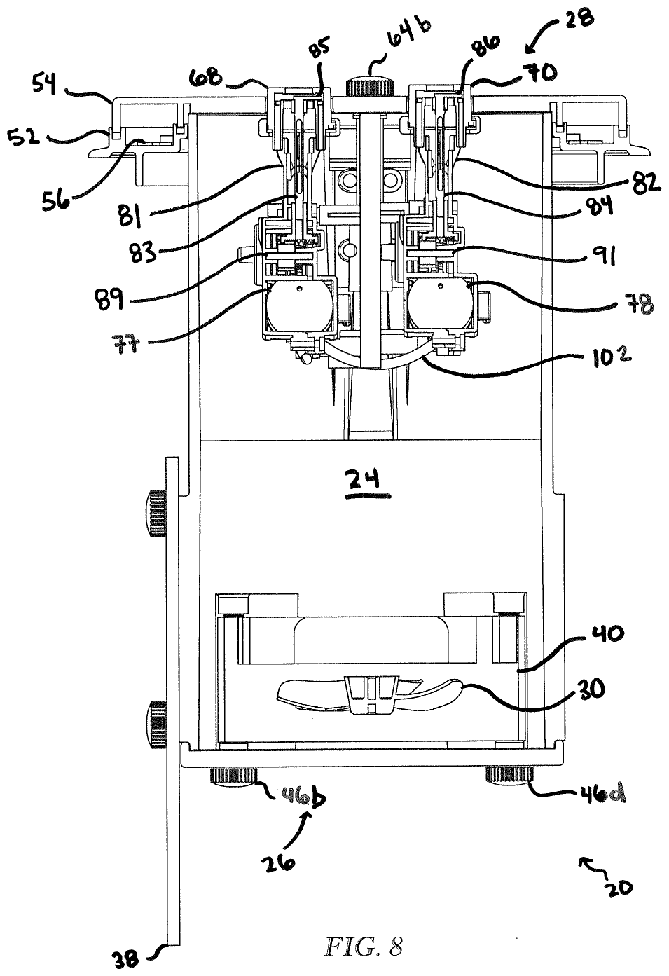

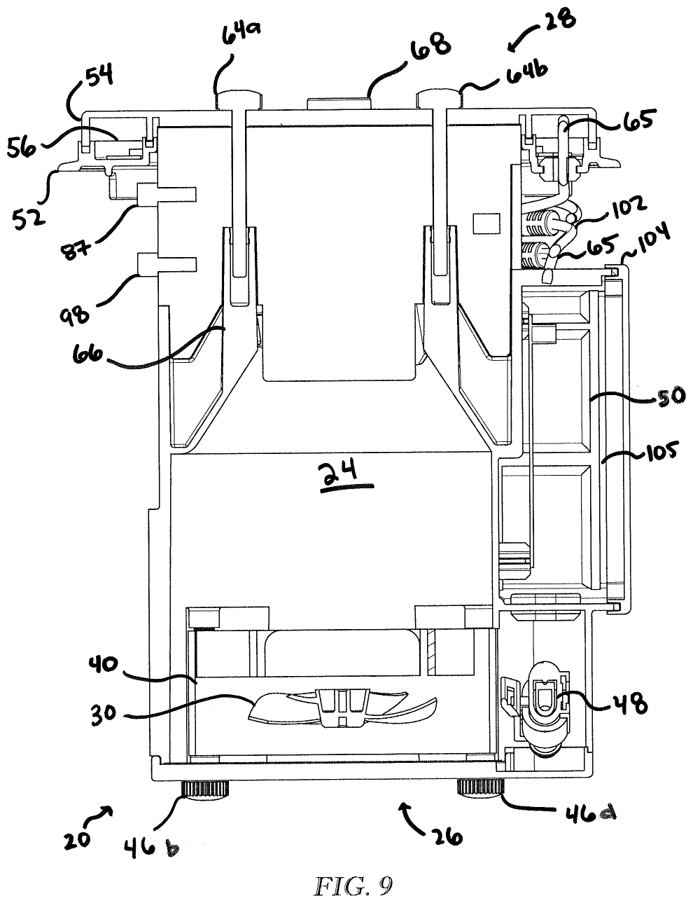

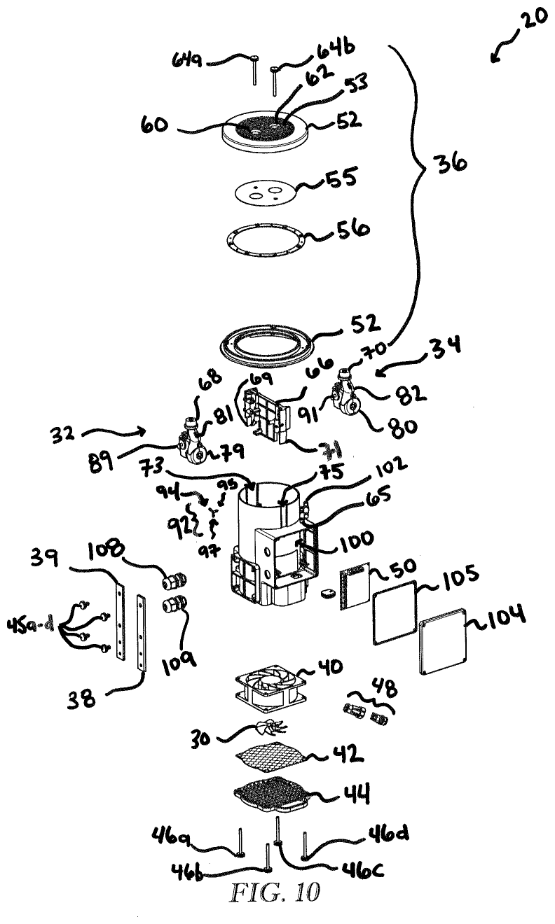

As shown in FIGS. 8-10, the fan 30 is secured within a guard assembly 40 within the first end 26 of the housing 24. The fan is positioned to push air through the hollow housing and out of the second end 28. More specifically, as shown in FIGS. 7 and 10, the guard assembly includes screw holes in its four outer corners, so that screws 46a-46d are secured therethrough. These screws also secure into the corners of a metal grill 42 and plastic grill 44, which grills are secured to an outer surface of the guard assembly towards the first end of the housing. These screws secure the grills and the guard assembly to the first end of the housing. By securing screws through both grills and the guard assembly, it ensures that the fan will not shift regardless of the direction in which it is positioned. The metal and plastic grills also advantageously protect the fan from external elements that may enter through the first end of the housing, such as small bugs or small rocks, which could damage the fan. Moreover, the combination of grills protects a user's fingers or hands from being injured from the propeller blades of the fan. As shown in FIGS. 9-10, the fan is electrically connected to a printed circuit board 50 (“PCB”) which is secured within the electronics control box 100 via a first cable 48. The fan is programmed to be activated via the PCB manually, remotely, and/or wirelessly.

As shown in FIGS. 1-6 and 10-11, securable to the second end 26 of the housing 24 is a cover assembly 36. The cover assembly is preferably a prefabricated cylindrical piece, which includes a base 52 and a lens 54 secured together. The lens includes an inner and outer circumference, wherein the outer circumference is preferably made of a material that is capable of transmitting light from a light emitting diode (“LED”) ring 56. The LED ring is secured between the base and the lens, preferably in the outer circumference thereof. This LED ring advantageously illuminates the lens and the bubbles that are emitted through the second end 28 of the housing 24. The LED ring is electrically connected to the PCB 50 via a second cable 58 and is programmed to be activated manually, remotely, and/or wirelessly. An inner circumference of the lens and the base includes a metal grill 53 and a plastic grill 55, which are made of a mesh pattern and advantageously allows air from the fan 30 to pass through the hollow housing and the grills. The design of the housing, and the grills allows the precise amount of air to flow from the fan and to push the bubbles at a significantly further distance than prior cannons. Prior cannons required a large fan or multiple fans, which made the cannon heavy and immobile, but due to the design of the present cannon, only a small fan is needed to push the bubbles at a far distance. Accordingly, the cannon is mobile and affixable at any angle to any surface. The metal and plastic grills are also beneficial as they protect the internal components of the housing from damage from environmental factors. As shown in FIGS. 1, 6 and 10, the cover assembly further includes a first and second opening (60, 62), centrally located within the metal and plastic grills into which a first and second nozzle (68, 70) of the first and second bubble cartridges (32, 34) secure. The elements of the cover assembly are secured via screws (64a, 64b), which secure into a cartridge mounting plate 66 within the housing. This advantageously secures the cover assembly to the mounting plate, while also securing the bubble cartridges in place within the housing. This ensures that these components do not shift or fall regardless of the position and direction in which the cannon 20 is affixed.

As shown in FIGS. 1-6 and 8-11, the first and second bubble cartridge (32, 34) are secured within the housing 24 so that the first and second nozzle (68, 70) of each cartridge is secured within the first and second opening (60, 62) of the cover assembly 36. More specifically, as shown in FIGS. 8 and 10, the first and second cartridge are secured in place to the mounting plate 66, via screws. The mounting plate is advantageously molded to include specific slots into which these cartridges snap fit. As shown in FIG. 10, the mounting plate includes two brackets (69, 71) on its outer edge, which slide into notches (73, 75) within a wall of the housing making the plate easily accessible and removeable if certain components need repair or replacement. The first and second bubble cartridges are assemblies which each include various components that work together to produce bubbles. Each cartridge contains the same components and although the embodiment shown in FIG. 10 includes two cartridges, this should not be construed as limiting. The number of cartridges varies depending on the size of the cannon 20 and is customizable depending on user specification. Advantageously, this cannon is designed to utilize minimal components, thereby reducing weight and allowing additional cartridges to be used. Furthermore, it is so efficient in not leaking and recirculating bubble solution that numerous cartridges can be used without constant need to replace the solution.

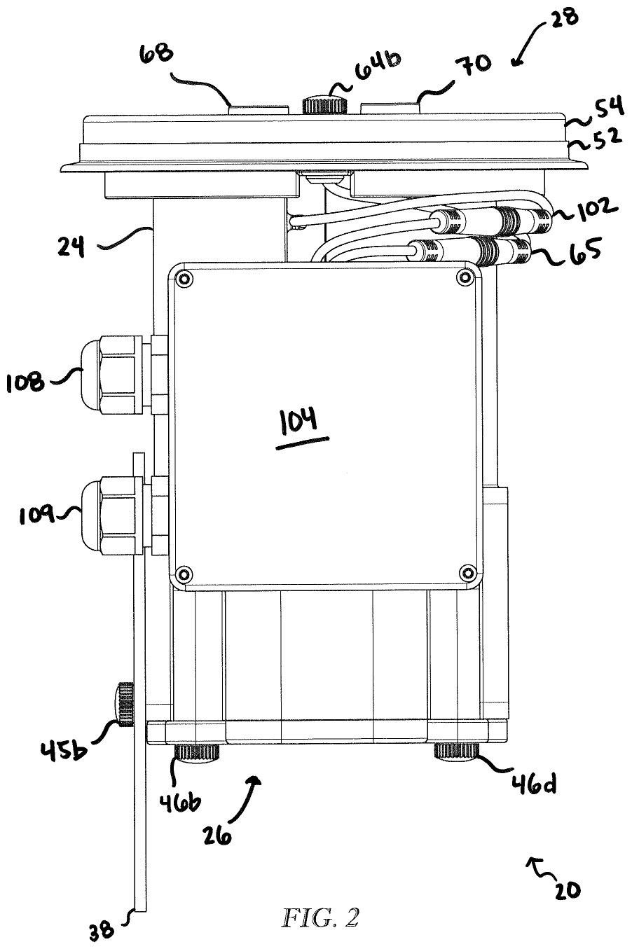

As shown in FIGS. 8 and 10, the first and second bubble cartridges (32, 34) each include an outer enclosure made of plastic that is specifically molded in manufacturing to form an air duct (81, 82) positioned adjacent to an air producing device (79, 80). Each enclosure of the first and second bubble cartridge also contains a motor (89, 91), a pump (77, 78) and various gears. Connected to the air ducts of the first and second bubble cartridges are the first and second nozzle, each of which contain a wiper (85, 86), which is secured to a drive shaft (83, 84). The drive shaft of each cartridge is electrically connected to the motor in each respective cartridge. As shown in FIGS. 2-5, and 7-9, the motor of each bubble cartridge is electrically connected to the to the PCB 50, via a third cable 102. The first and second bubble cartridges are activated independently and/or in conjunction and are activated manually, wirelessly, and/or remotely. When activated, the motor of the respective first and second bubble cartridges begins rotating the air producing devices and the gears of the peristaltic pumps. The PCB activates the motors of one or both bubble cartridges independently or simultaneously. The motors also simultaneously rotate the drive shafts of each cartridge via a worm gear to begin rotating the wipers within the nozzles. When the motors are activated manually via a user or wirelessly via a signal received, the air producing devices begins pushing air through the air ducts and through the nozzles.

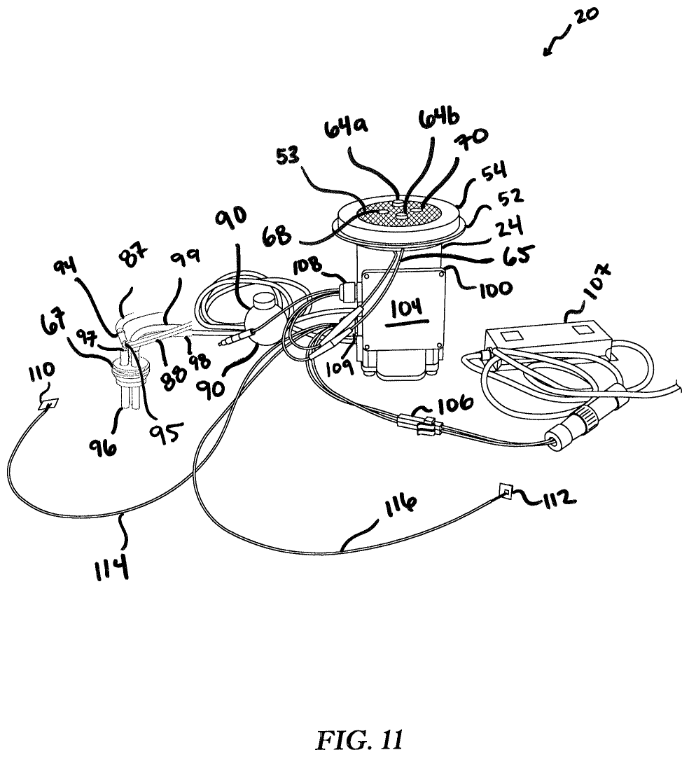

As shown in FIGS. 1, 3, 5, 9 and 11, a first solution channel 87 is secured through the wall of the housing 24 and travels through the first pump 77 and connects to the first nozzle 68 so that it drips bubble producing solution onto a first wiper 85. As shown in FIGS. 1, 3-4, and 11, a second solution channel 88 is secured through the wall of the housing and travels through the second pump 78 and connects to the second nozzle 70 so that it drips bubble producing solution onto a second wiper 86. The first and second channels are tubular in structure and allow bubble solution to be pumped therethrough as an opposite end of these solution channels are submerged within a bubble solution reservoir 90. As shown in FIG. 11, this reservoir is affixable to the outer surface of the housing and is advantageously easily refillable. In use, when the motor of each bubble cartridge is activated, solution is pumped from this reservoir and into the first and second solution channels through a lid 67 that seals the solution within the reservoir, thereby preventing leakage regardless of the position in which the cannon 20 is affixed. The solution drips into the nozzles and forms a film via the rotation of the wiper so that air pushed from the air producing devices propels the film into bubbles from the nozzles

A converter 92 is utilized and is secured within the lid 67 to ensure the precise amount of solution is pumped from the reservoir 90 and through the first and second solution channels (87, 88). As shown in FIGS. 10 and 11, the converter 92 is in the shape of a y split and therefore has a first tip 94, a second tip 95 and a third tip 97. The first and second tips of the y split converter connect to the first and second solution channel. The first and second tips and respective first and second channels are of a smaller diameter tubing than the third tip and third channel 96. The third solution channel is submerged within the solution reservoir and connected to a third tip of the converter. The use of a Y split converter permits the pumping of the precise amount of solution from the reservoir and through the first and second solution channels evenly so that ample bubbles are produced consistently and evenly from the first and second nozzles (68, 70) at a precise rate, while also not overwhelming the bubble cannon. The smaller first and second channels are reduced in diameter from the third larger channel by at least ten percent, preferably about ten to seventy percent, most preferably about ten to fifty percent. The converter functions to reduce the quantity of the solution and the size of the openings through which the solution passes. The converter reduces the quantity of passing solution by at least ten percent, preferably about ten to seventy percent, most preferably about ten to fifty percent. The channels are snug fit around the specifically sized tips, so the converter not only splits this original tubing, but also decreases the tubing size to a smaller diameter tubing. This allows the cannon to not leak even with two channels and allows only one reservoir to be utilized, further achieving the mobility and compactness of this cannon. Furthermore, the conversion from a larger diameter tubing to the smaller diameter tubing ensures that an overproduction of solution is not an issue, thereby resolving any overflow issues of liquid throughout the cannon. Moreover, the use of the Y split is advantageous as solution is only pumped through the respective solution channel depending on which motor of the first and second bubble cartridges (32, 34) is activated.

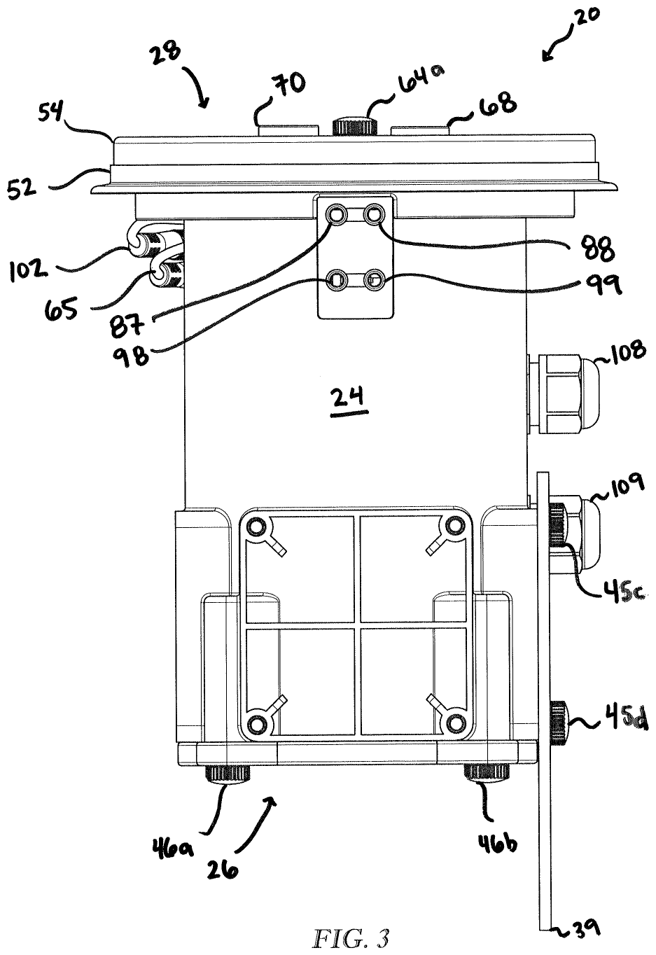

As shown in FIGS. 3 and 11, a first recirculation channel 98 and second solution recirculation channel 99 are secured through the wall of the housing 24 so that first recirculation channel is connected to the first nozzle 68 and a second recirculation channel is connected to the second nozzle 70. These recirculation channels catch any excess bubble solution that forms within an inner compartment of the nozzles and advantageously drains this excess solution back to the solution reservoir 90. This recirculation provides an improved bubble cannon 20 as solution is recirculated from both nozzles, which adds to the longevity of the cannon without the need to constantly replace the solution and prevents leakage of excess solution into the cannon.

Accordingly, in use, each or one of the motors (89, 91) in the first and second bubble cartridges (32, 34) are activated, the bubble solution is pumped from the reservoir 90 and into the first and second solution channels (87, 88) via the respective pumps (77, 78). The respective air producing devices (79, 80) are activated and push air through the air ducts (81, 82) and out the first and second nozzles (68, 70). When the motors are activated, they begin rotating the respective wipers (85, 86) 360 degrees around the inside of each nozzle. Bubble solution is pumped into each nozzle and forms a film around the inside of the nozzles. The air from the air producing devices pushes this film into bubbles and out of each nozzle. Advantageously to aid in projecting the bubbles at a further distance is the design of the cover assembly, namely, the mesh patterned metal and plastic grill (53, 55) which allows air from the fan 30 to push the bubbles at an even further distance. The bubbles are therefore pushed via the air from each air producing device and the fan. The bubble cannon 20 therefore propels more bubbles at a further distance than prior known devices and achieves this result utilizing less components.

As shown in FIGS. 1, 2, 4-11, secured to an outer surface of the housing 24 is an electronics control box 100. This box houses the PCB 50, which is electrically connected to various components of the cannon 20 that require instruction and programming for activation. As shown in FIGS. 1-5 and 9-11, the control box is enclosed via a control box compartment cover 104, which is secured to the box via screws. The control box further includes an additional panel 105, as shown in FIG. 10, which protects the PCB and other electrical connections from potential damage from bubble solution falling within the bubbles that are produced. To further in making the control box and electrical connection thereto waterproof are a first and second terminal (108, 109) secured into an outer surface of the box and into which the various cables secure. As shown in FIG. 11, this PCB is also electrically connected to a power source 107 via a fourth cable 106. This power source is plugged into an outlet to provide power to the cannon. However, the cannon is also capable of being powered wirelessly, for instance via batteries. The PCB is preprogrammed, for instance via an integrated circuit electrically connected thereto, to activate the LED ring 56, the first and second bubble cartridges (32, 34) and the fan 30 independently and/or in conjunction with one another. As shown in FIG. 11, the cannon includes a receiver 110 and a transmitter 112, which are electrically connected to the PCB via a fifth and sixth cable (114, 116). The transmitter and receiver are, for example, infrared and are affixable to any surface of the cannon depending on the direction in which the cannon is secured. The transmitter and receiver are positioned so that the cannon receives and transmits signals from a third-party source. In use, when plugged into a power source and/or activated via batteries, the components of the bubble cannon are activated. The LED ring is activated and illuminates in a preprogrammed sequence and various colors for a specific timing. The first and/or second bubble cartridges are activated and begin producing bubbles through the first and second nozzles (68, 70). Simultaneously, the fan 30 is activated and begins pushing air though the hollow housing. This creates a unique viewer experience of illuminated bubbles projected at a unique angle and at a surprising distance. In addition, the housing includes a speaker, which is electrically connected to the PCB and, when activated, plays a programmed sound. When activated, the cannon is also ready to receive and transmit signals and is activated wirelessly. When the IR receiver receives a signal from a nearby device, various features of the bubble cannon are activated, which are preprogrammed onto the PCB, such as bubble production, illumination of the LED ring 56, sound played through the speaker and/or activation of the fan. The data received by the receiver is transmitted to the PCB and all functions of the cannon are activated. Further, the cannon is programmed to automatically send a signal back to the device that originally sent the signal and/or to a separate device to effectuate a unique effect in that device.

As shown in FIGS. 12-13, due to the lightweight nature of the bubble cannon 20, it is easily secured into or onto any device, such as a mobile cart 22, which is for instance made of fiberglass. In this embodiment, the components are the cannon are the same as described herein and due to the compact and lightweight nature of the cannon, they are secured within a globular housing 118 that is affixed to or forms part of the mobile cart. As shown in FIG. 12, the receiver 112 and transmitter 114 are secured through an outer surface of the globular housing so that the cannon is activated wirelessly via a received signal and transmits a signal back to the device that activated sent the original signal. As shown in FIG. 13, the cart includes various shelves that include slots into which these devices are situated. Accordingly, for example, a user may grab a device situated within the cart and send a unique signal from that device to the cannon to activate it wirelessly. This unique signal activates various functions of the cannon specific to that signal. Simultaneously, the cannon sends the unique signal back to the device, which activates a similar function within the device. Moreover, due to the surprising compactness and lightweight nature of the cannon, the cart is mobile and able to easily be pushed.

It is well recognized by persons skilled in the art that alternative embodiments to those disclosed herein, which are foreseeable alternatives, are also covered by this disclosure. The foregoing disclosure is not intended to be construed to limit the embodiments or otherwise to exclude such other embodiments, adaptations, variations, modifications and equivalent arrangements.

1. A bubble cannon comprising:
a housing with a first and second end;
a fan secured within the first end of the housing;
a cover assembly secured to the second end of the housing and containing an opening;
at least one bubble cartridge secured within the housing, wherein the at least one bubble cartridge comprises an enclosure containing a pump, a motor and an air producing device positioned adjacent to an air duct;
a nozzle secured to the air duct and positioned within the opening, wherein the nozzle contains a wiper;
an electronics control box securable to a side of the housing, wherein the control box contains a printed circuit board;
a bubble solution reservoir secured to a side of the housing; and
a solution channel with a first and second end, wherein the first end is submerged within the reservoir and the second end is connected to the nozzle.

2. The bubble cannon of claim 1, further comprising an LED ring secured within the cover assembly.

3. The bubble cannon of claim 1, wherein an inner portion of the cover assembly comprises a mesh grill.

4. The bubble cannon of claim 3, wherein the fan is positioned to direct air through mesh grill of the cover assembly.

5. The bubble cannon of claim 1, further comprising at least one receiver secured to the housing and electrically connected to the printed circuit board.

6. The bubble cannon of claim 1, further comprising a mesh grill secured over the fan on the first end of the housing.

7. The bubble cannon of claim 1, further comprising a mounting plate securable to the side of the housing.

8. The bubble cannon of claim 1, further comprising a recirculation channel with a first and second end, wherein the first end is connected to a drain in the nozzle and the second end is connected to the reservoir.

9. A bubble cannon comprising:
a cylindrical housing with a first and second end;
a fan secured within the first end of the housing;
a cover assembly secured to the second end of the housing, wherein the cover assembly comprises a base secured to a lens with an LED ring secured therebetween;
at least one bubble cartridge secured within the housing, wherein the at least one bubble cartridge comprises an enclosure containing a pump, a motor and an air producing device positioned adjacent to an air duct;
a nozzle secured to air duct within the cover assembly of the housing, wherein the nozzle contains a wiper;
an electronics control box securable to a side of the housing, wherein the control box contains a printed circuit board;
a bubble solution reservoir secured to a side of the housing; and
a solution channel with a first and second end, wherein the first end is submerged within the reservoir and the second end is connected to the nozzle.

10. The bubble cannon of claim 9, wherein the LED ring is secured around an outer circumference of the cover assembly.

11. The bubble cannon of claim 9, further comprising at least one receiver secured to the housing.

12. The bubble cannon of claim 9, further comprising a mesh grill secured over the fan on the first end of the housing.

13. The bubble cannon of claim 9, further comprising a mounting plate securable to the side of the housing, wherein the brackets are securable to a mobile cart.

14. The bubble cannon of claim 9, wherein an inner circumference of the cover assembly comprises a mesh grill.

15. The bubble cannon of claim 14, wherein the fan is positioned to direct air through mesh grill of the cover assembly.

16. A bubble cannon comprising:
a cylindrical housing with a first and second end;
a fan secured within the first end of the housing;
a cover assembly secured to the second end of the housing, wherein the cover assembly comprises a base secured to a lens with an LED ring secured therebetween, wherein an inner circumference of the cover assembly comprises a mesh grill with a first and second opening;
a first and second bubble cartridge secured within the housing, wherein the first and second cartridge each comprise an enclosure containing a pump, a motor and an air producing device positioned adjacent to an air duct;
a first nozzle secured to the first air duct within the first opening of the cover assembly, wherein the first nozzle contains a first wiper;
a second nozzle secured to the second air duct within the second opening of the cover assembly, wherein the second nozzle contains a second wiper
an electronics control box securable to a side of the housing, wherein the control box contains a printed circuit board;
a bubble solution reservoir secured to a side of the housing; and
a first and second solution channel, each comprising a first and second end, wherein the first end of the first and second solution channel is submerged within the reservoir and the second end of the first solution channel is connected to the first nozzle and the second end of the second channel is connected to the second nozzle.

17. The bubble cannon of claim 16, further comprising at least one receiver secured to the housing.

18. The bubble cannon of claim 16, further comprising a mesh grill secured over the fan on the first end of the housing.

19. The bubble cannon of claim 16, further comprising a mounting plate securable to the side of the housing, wherein the brackets are securable to a mobile cart.

20. The bubble cannon of claim 16, wherein the fan is positioned to direct air through mesh grill of the cover assembly.
